(19) United States
(12) Patent Application Publication
(10) Pub. No.: US 2010/0192079 A1
(43) Pub. Date: Jul. 29, 2010

(54) Display apparatus, displaying method, and program

(75) Inventor: Koji Nagahiro, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/657,742

(22) Filed: Jan. 27, 2010

(30) Foreign Application Priority Data
Jan. 29, 2009 (JP) P2009-018662

(51) Int. Cl. G06F 3/048

(52) U.S. Cl. 715/765; 715/848

(57) ABSTRACT

There is provided is a display apparatus including: a displaying position setting unit that sets displaying positions of the contents data based on a display starting position, at which the displaying of the contents data is started; and a display controller that allows the contents data displayed on the display screen to be moved from the display starting position toward the displaying positions so as to be displayed based on the display starting position and the displaying positions set by the displaying position setting unit.

### CROSS-REFERENCE TO RELATED APPLICATION

The present application claims priority from Japanese Patent Application No. JP 2009-018662 filed in the Japanese Patent Office on Jan. 29, 2009, the entire content of which is incorporated herein by reference.

### BACKGROUND OF THE INVENTION

1. Field of the Present Invention

The present invention relates a display apparatus, a displaying method, and a program.

2. Description of the Related Art

As a method of displaying a plurality of contents data such as a still picture or a moving picture on one display screen, there is disclosed, for example, a display method called thumbnail display or index display. In addition, recently, various technologies associated with the displaying of the contents data have been developed. For example, Japanese Unexamined Patent Application Publication No. 2006-237876 discloses a technology of displaying a larger number of pieces of information on a display screen.

A method in the related art associated with the displaying of the contents data (hereinafter, simply referred to as a “method in the related art”) is a technology associated with the index display based on the point of view in that a larger number of pieces of information are displayed on the display screen, that is, in a limited display area. More specifically, in the technology in the related art, down-scaled pictures of the picture data to be displayed on the display screen are generated, and aspect ratios of the down-scaled pictures are adjusted according to the aspect ratio of the display screen. Therefore, a display apparatus adapted to the technology in the related art (hereinafter, referred to as a “display apparatus in the related art”) may display a large number of pieces of information on the display screen and implement the index display so that a user may more easily view the contents data.

Recently, since the display apparatus such as an LCD (liquid crystal display) has been configured to have a large size, the display area capable of displaying the information has been also increased. Therefore, in the case of using the technology in the related art, for example, as the size of the display screen is increased, the number of the contents data (strictly speaking, the down-scaled pictures based on the contents data) displayed on the display screen by the index display has increased. In addition, in the technology in the related art, the contents data are displayed on the display screen according to the existing displaying method associated with tabular display of a plurality of the contents data such as the index display or the thumbnail display. In other words, in the display apparatus in the related art, for example, the tabular display of the contents data, which are orderly arranged in a matrix, is merely shown to the user. Therefore, although an information amount of the display screen is increased by using the technology in the related art, it may be difficult for the user of the display apparatus in the related art to check the desired contents data. Therefore, the displaying method according to the technology in the related art using the displaying method in the related art such as the index display or the thumbnail display may not allow the user to easily check the contents data.

In addition, in the display apparatus in the related art, for example, even in the case where new contents data are input from an external recording medium such as a storage unit included in an external apparatus, the user may merely view the pictures that are arranged in advance in the album. This problem also occurs, for example, in the case where the display apparatus in the related art reads out the contents data from the external recording medium. Therefore, in the case where the technology in the related art is used, the user may be provided with a feeling that the user is “dealing with data”, but the invention is not expected that the user is provided with a feeling that the user is “dealing with pictures”.

### SUMMARY OF THE INVENTION

It is desirable to provide a new, improved display apparatus, displaying method, and program capable of implementing intuitive displaying so that a user may more easily view contents data in a case where a plurality of contents data is displayed on a display screen.

According to a first embodiment of the present invention, there is provided a display apparatus including: a displaying position setting unit that sets displaying positions of the contents data based on a display starting position, at which the displaying of the contents data is started; and a display controller that allows the contents data displayed on the display screen to be moved from the display starting position toward the displaying positions so as to be displayed based on the display starting position and the displaying positions set by the displaying position setting unit.

According to the above configuration, in the case where a plurality of the contents data is displayed on the display screen, intuitive displaying may be implemented so that a user may easily view the contents data.

In addition, the display apparatus may further include a contents data input unit to which the contents data are input, wherein the displaying position setting unit determines the display starting position based on a position provided by the contents data input unit to which the contents data are input.

In addition, the display controller may derive distances between the display starting position and the displaying positions based on the display starting position and the set displaying positions to display the contents data in the order from the displaying position according to the length of the derived distance.

In addition, the display apparatus may further include a displaying-number determining unit that determines a displaying number of contents data displayed on a display screen, wherein the displaying position setting unit may determine displaying sizes of the contents data displayed on the display screen based on the displaying number determined by the displaying-number determining unit, and wherein the display controller may allow the contents data to be displayed in sizes according to the displaying sizes determined by the displaying position setting unit.

In addition, the displaying position setting unit may further determine displaying sizes of the contents data based on meta information set in the contents data.

In addition, the displaying position setting unit may set the displaying position in a three-dimensional space defined by the horizontal direction and vertical direction of the display screen and the perpendicular direction with respect to the display screen.

In addition, the displaying position setting unit may set the displaying position in a two-dimensional plane defined by the horizontal direction and vertical direction of the display screen.

According to a second embodiment of the present invention, there is provided a displaying method including the steps of: setting displaying positions of the contents data based on a display starting position, at which the displaying of the contents data is started; and allowing the contents data displayed on the display screen to be moved from the display starting position toward the displaying positions so as to be displayed based on the display starting position and the displaying positions set by the displaying position setting unit.

By using the above method, in the case where a plurality of the contents data is displayed on the display screen, intuitive displaying may be implemented so that a user may easily view the contents data.

According to a third embodiment of the present invention, there is provided a program causing a computer to execute: a function of setting displaying positions of the contents data based on a display starting position, at which the displaying of the contents data is started; and a function of allowing the contents data displayed on the display screen to be moved from the display starting position toward the displaying positions so as to be displayed based on the display starting position and the displaying positions set by the displaying position setting unit.

By using the above program, in the case where a plurality of the contents data is displayed on the display screen, intuitive displaying may be implemented so that a user may easily view the contents data.

According to the invention, in the case where a plurality of the contents data is displayed on the display screen, intuitive displaying may be implemented so that a user may easily view the contents data.

### BRIEF DESCRIPTION OF THE DRAWINGS

FIG. 1A is a diagram illustrating a displaying method in a display apparatus in the related art.

FIG. 1B is a diagram illustrating a displaying method in a display apparatus in the related art.

FIG. 2A is a diagram illustrating a displaying method in a display apparatus according to an embodiment of the invention.

FIG. 2B is a diagram illustrating a displaying method in a display apparatus according to an embodiment of the invention.

FIG. 2C is a diagram illustrating a displaying method in a display apparatus according to an embodiment of the invention.

FIG. 3 is a first diagram illustrating a method of determining a displaying size of contents data in a display apparatus according to an embodiment of the invention.

FIG. 4 is a second diagram illustrating a method of determining a displaying size of contents data in a display apparatus according to an embodiment of the invention.

FIG. 5 is a diagram illustrating an example of a display starting position determined by a display apparatus according to an embodiment of the invention.

FIG. 6 is a diagram illustrating a first example of a method of deriving displaying position candidates in a display apparatus according to an embodiment of the invention.

FIG. 7A is a diagram illustrating a second example of a method of deriving displaying position candidates in a display apparatus according to an embodiment of the invention.

FIG. 7B is a diagram illustrating the second example of a method of deriving displaying position candidates in a display apparatus according to an embodiment of the invention.

FIG. 8 is a diagram illustrating the second example of a method of deriving displaying position candidates in a display apparatus according to an embodiment of the invention.

FIG. 9 is a diagram illustrating a first example of a displaying process in a display apparatus according to an embodiment of the invention.

FIG. 10 is a diagram illustrating a second example of a displaying process in a display apparatus according to an embodiment of the invention.

FIG. 11 is a diagram illustrating a display example of contents data displayed on a display screen of a display apparatus according to an embodiment of the invention.

FIG. 12 is a flowchart illustrating an example of a process in a display apparatus according to an embodiment of the invention.

FIG. 13 is a diagram illustrating an example of a configuration of a display apparatus according to an embodiment of the invention.

FIG. 14 is a diagram illustrating an example of a hardware configuration of a display apparatus according to an embodiment of the invention.

### DESCRIPTION OF THE PREFERRED EMBODIMENTS

Hereinafter, exemplary embodiments of the invention will be described with reference to the accompanying drawings. In addition, in the specification and drawings, elements having the substantially same functional configurations are denoted by the same reference numerals, and description thereof is omitted.

In addition, hereinafter, the description will be made in the following order.

1. Display Method According to Embodiment of the Invention

2. Display Apparatus According to Embodiment of the Invention

3. Program According to Embodiment of the Invention

### DISPLAY METHOD ACCORDING TO EMBODIMENT OF THE INVENTION

A method of displaying contents data according to an embodiment of the invention is described before a display apparatus according to the embodiment of the invention is described.

Hereinafter, a method of displaying contents data on a display screen of the display apparatus is described. Herein, the contents data according to the embodiment of the invention are data representing contents displayed on the display screen. As an example of the contents data, there are picture data representing a still picture or a moving picture, but they are not limited thereto. For example, the contents data according to the embodiment of the invention may include meta data, in which various types of information are recorded, and audio data corresponding to a picture (still picture/moving picture) represented by the picture data.

### Overview of Display Method According to Embodiment of the Invention

### Display Method in the Related Art

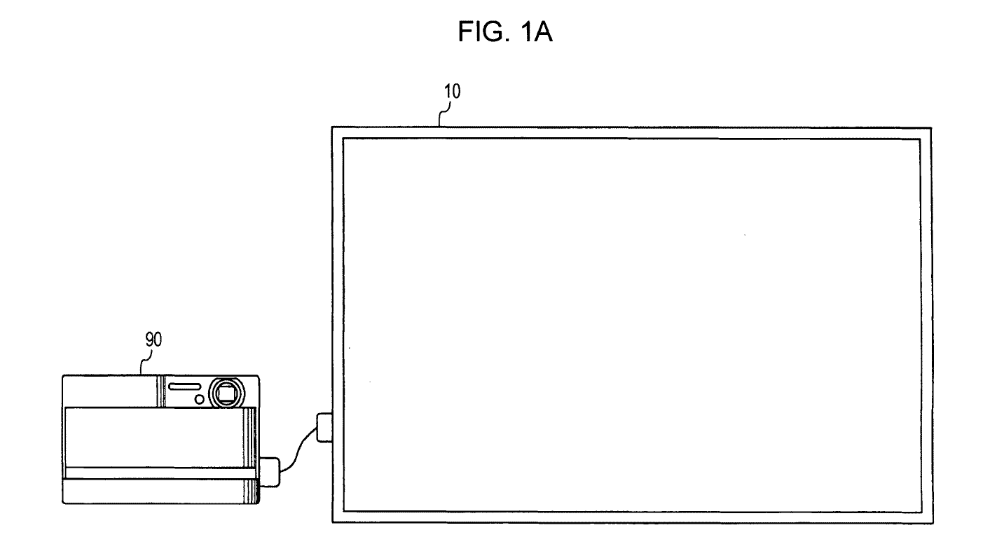

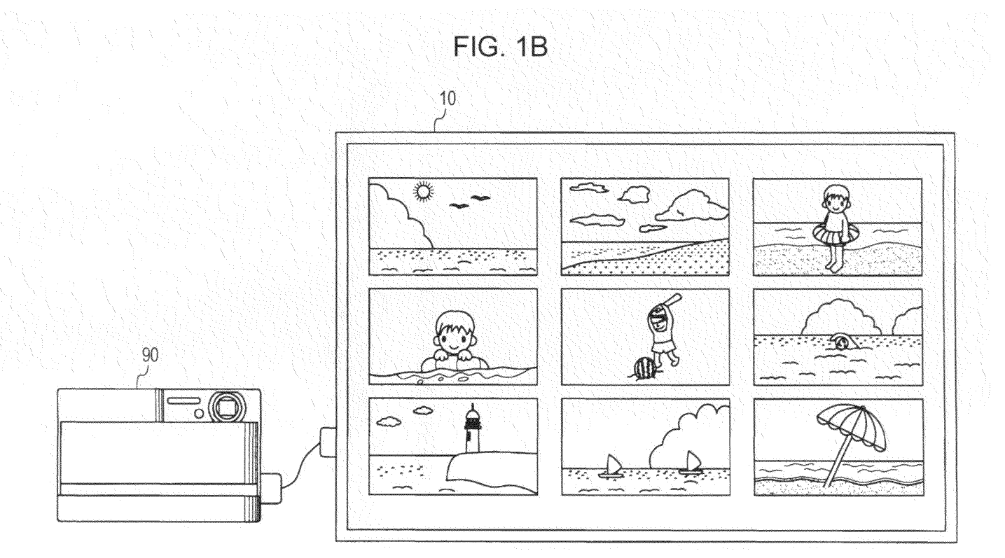

Before the overview of the method of displaying the contents data according to the embodiment of the invention is described, a display method in the related art in a display apparatus in the related art (hereinafter, referred to as a “display apparatus 10”) is firstly described. FIGS. 1A and 1B are diagrams illustrating displaying methods in the display apparatus 10 in the related art. Herein, FIGS. 1A, and 1B illustrate examples where the display apparatus 10 performs thumbnail display based on the contents data input from the external apparatus 90. More specifically, FIG. 1A illustrates the state before the contents data recorded in the external apparatus 90 is input to the display apparatus 10, and FIG. 1B illustrates an example of the state where the display apparatus 10 displays the contents data recorded in the external apparatus 90 on the display screen. In addition, in FIGS. 1A and 1B, the external apparatus 90 denotes a digital camera.

In the case where a plurality of contents data recorded in the external apparatus 90 is displayed on the display screen in a tabular format, the display apparatus 10 reads the contents data from the external apparatus 90, for example, based on a user's manipulation and generates a down-scaled picture (so-called a thumbnail picture) based on the contents data. Next, as shown in FIG. 1B, the display apparatus 10 displays generated down-scaled pictures, for example, arranged in a matrix in the tabular format. In other words, as shown in FIG. 1B, the display apparatus 10 displays the contents data (strictly speaking, the down-scaled pictures) on the display screen in a displaying method in the related art, which is called an “index display” or “thumbnail display” where the down-scaled pictures are orderly arranged in a matrix on the display screen. Herein, since the displaying method in the related art such as the index display is, for example, a displaying method for showing pictures that are orderly arranged in advance in an album to a user, so that it is difficult for the user to feel as if the user is “dealing with pictures”.

### Display Method According to Embodiment of the Invention

In the display apparatus (hereinafter, referred to as a “display apparatus 100”) according to the embodiment of the invention, a plurality of contents data are displayed on the display screen according to a displaying method different from the displaying method in the related art shown in FIG. 1B. More specifically, the display apparatus 100 uses a displaying method capable of providing the user with a feeling that the user is “dealing with pictures” in comparison with a displaying method in the related art, so that intuitive displaying may be implemented so that the user may more easily check the contents data.

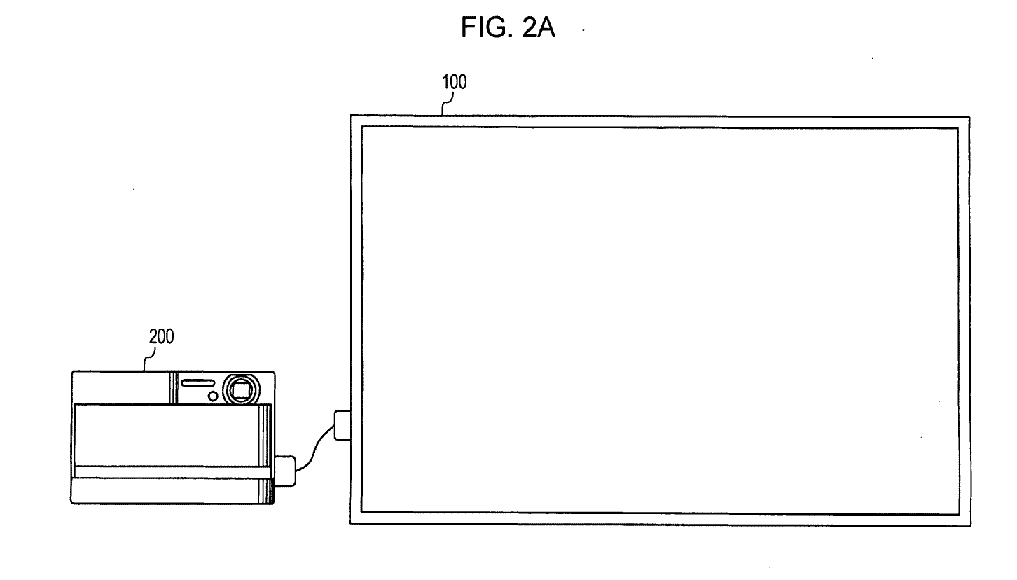

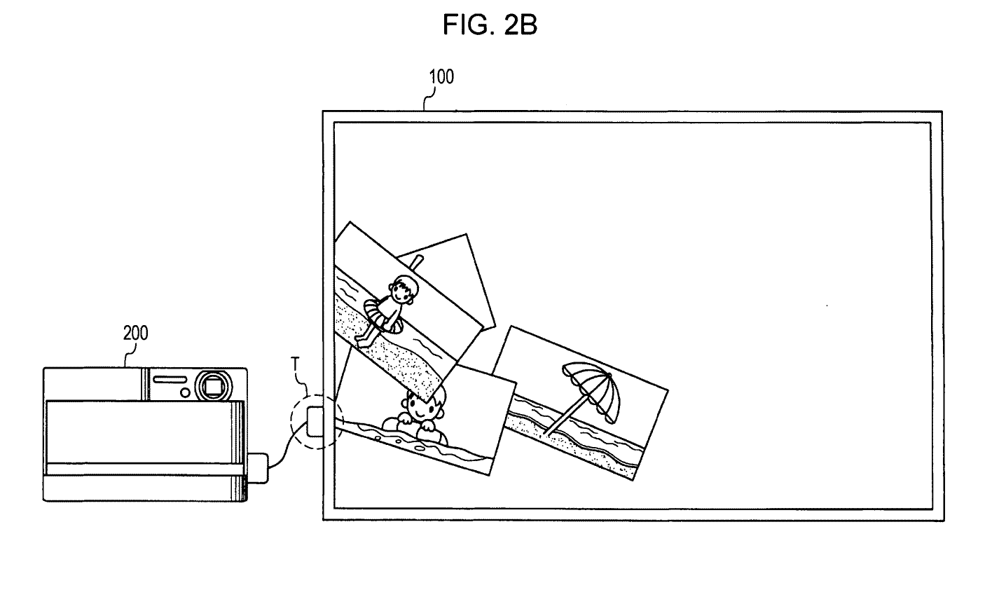

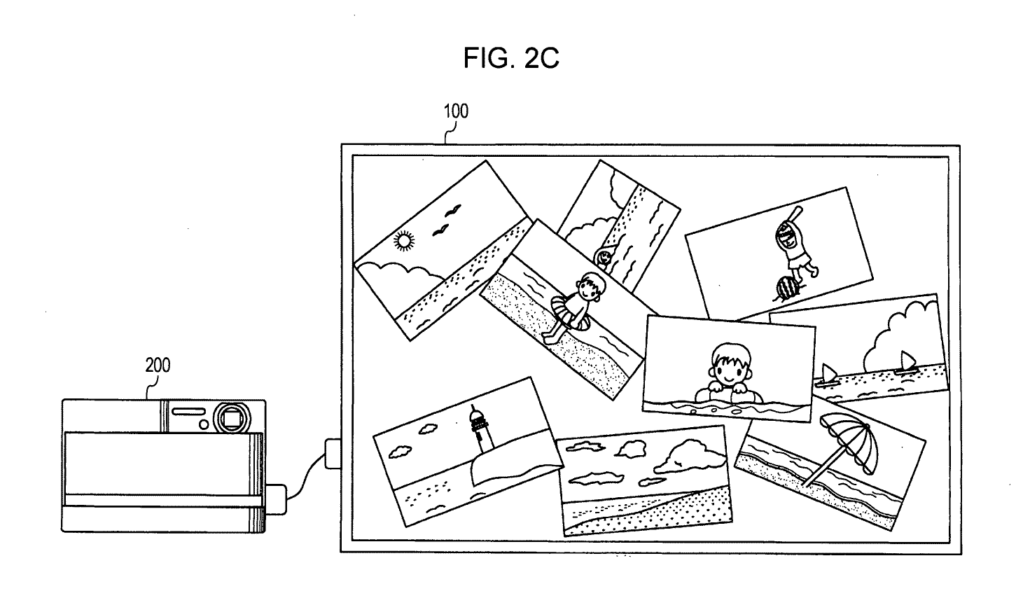

Hereinafter, an overview of the contents data displaying method in the display apparatus 100 according to the embodiment of the invention is described with reference to FIGS. 2A to 2C. FIGS. 2A to 2C are diagrams illustrating displaying methods in the display apparatus 100 according to the embodiment of the invention. Herein, FIG. 2A illustrates a state before the contents data recorded in an external apparatus (hereinafter, referred to as an “external apparatus 200”), which may store the contents data, are input to the display apparatus 100. In addition, FIG. 2B illustrates an example of a state of a displaying operation in which the display apparatus 100 is displaying the contents data recorded in the external apparatus 200 on the display screen, and FIG. 2C illustrates an example of a state in which the display apparatus 100 displays the contents data recorded in the external apparatus 200 on the display screen.

In addition, in FIGS. 2A to 2C, a digital camera is exemplified as the external apparatus 200, but the external apparatus 200 according to the embodiment of the invention is not limited thereto. For example, as the external apparatus 200 according to the embodiment of the invention, there may be a recording medium such as a USB (universal serial bus) memory, a memory stick, or a hard disk or various apparatuses having the recording medium. In addition, the display apparatus 100 and the external apparatus 200 may be directly connected to each other in a wired/wireless manner or indirectly through a network or the like. Herein, as an example of the network, there is a wired network such as a LAN (local area network) or WAN (wide area network), a wireless network such as a wireless WAN (WWAN; wireless wide area network) or a wireless MAN (WMAN; wireless metropolitan area network) using a base station, or the Internet using a communication protocol such as TCP/IP (transmission control protocol/Internet protocol), but the invention is not limited thereto.

In addition, the “connection” according to the embodiment of the invention denotes, for example, to be in the state where the apparatuses are communicatable (or the apparatuses are allowed to be in the communicable state). In other words, by connecting the display apparatus 100 and the external apparatus 200, the display apparatus 100 is allowed to receive the contents data recorded in the external apparatus 200. In addition, the display apparatus 100 may be configured to transmit the contents data to the external apparatus 200.

Hereinafter, the displaying method according to the embodiment of the invention is described by exemplifying the case where the external apparatus 200 is connected to the display apparatus 100 in a wired manner and the display apparatus 100 displays the contents data input from the external apparatus 200 on the display screen as shown in FIGS. 2A to 2C. In addition, hereinafter, the case the display apparatus 100 displays on the display screen the contents data which are stored in the external apparatus 200 and input from the external apparatus 200 is exemplarily described, but the invention is not limited thereto. For example, similar to the displaying method in the related art, the display apparatus 100 may generate the down-scaled pictures (so-called the thumbnail pictures) based on the contents data input from the external apparatus 200 and display the generated down-scaled pictures in the below-described displaying method.

If the display apparatus 100 and the external apparatus 200 are connected to each other (FIG. 2A) and if the contents data are input from the external apparatus 200, the display apparatus 100 starts the displaying of the contents data input from the external apparatus 200. At this time, the display apparatus 100 sequentially displays the contents data as if the input contents data show up from a position (T in FIG. 2B, that is, position near a connection port) corresponding to a connection port connected to the external apparatus 200 (FIG. 2B). As a result, the contents data input from the external apparatus 200 are displayed on the display screen of the display apparatus 100, for example, in the state where physical pictures are randomly spread out on a desk (FIG. 2C).

The display apparatus 100 displays on the display screen the contents data input from the external apparatus 200, for example, according to the displaying method shown in FIGS. 2A to 2C. Herein, for example, by using the displaying method shown in FIGS. 2A to 2C, the user of the display apparatus 100 may visually check that the contents data displayed on the display screen are the contents data input from the external apparatus 200. Therefore, by using the displaying method according to the embodiment of the invention shown in FIGS. 2A to 2C, the display apparatus 100 may implement the more intuitive displaying than the displaying method in the related art.

In addition, at the time of displaying a plurality of the contents data, the display apparatus 100 forms, for example, a visual state in which physical pictures are simply spread out on a desk, so that a feeling that the user is “dealing with pictures” is provided to the user in comparison with the displaying method in the related art.

In addition, the display apparatus 100 does not orderly arrange a plurality of the contents data in a matrix unlike the displaying method in the related art (FIG. 2C). More specifically, as shown in FIG. 2C, the display apparatus 100 allows the contents data to be display on the display screen, for example, in random directions and in an overlapped state. In other words, in the displaying method in the related art, the contents data are orderly arranged in a matrix, so that the displayed state of the contents data is uniform. However, in the display apparatus 100, the displayed state of the contents data is not uniform. Therefore, by using the displaying method shown in FIG. 2C, the display apparatus 100 may change an information amount associated with the displayed state of the contents data. Therefore, in comparison with the case where the displaying method in the related art is used, the display apparatus 100 may raise a user's awareness of the contents data displayed on the display screen. In addition, since the display apparatus 100 may further raise a user's awareness of the contents data displayed on the display screen, the user may more easily find the desired contents data than the case where the displaying method in the related art is used.

Therefore, by using the displaying method according to the embodiment of the invention shown in FIGS. 2A to 2C, the display apparatus 100 may implement intuitive displaying so that the user may more easily check the contents data in the case where a plurality of the contents data is displayed on the display screen. In addition, by using the displaying method according to the embodiment of the invention, the display apparatus 100 may more effectively display the contents data to the user than the case of using the displaying method of the contents data in the related art.

In addition, in the aforementioned embodiment, as shown in FIGS. 2A to 2C, the description is made by exemplifying the case where the display apparatus 100 displays the contents data stored in the external apparatus 200, but the invention is not limited thereto. For example, the display apparatus 100 may display the contents data stored in the storage unit (described later) included in the display apparatus 100 on the display screen, for example, in the state where physical pictures are simply spread out on a desk as shown in FIGS. 2B and 2C. In the above case, as the display starting position (for example, the position corresponding to T in FIG. 2B) at which the contents data show up to be displayed, there is, for example, a predetermined position such as a central position of the display screen or a central position of a bottom surface or a position corresponding to the position provided by the storage unit, but the invention is not limited thereto. In addition, in the case where the contents data recorded in the external recording medium received into the display apparatus 100 are displayed, the display apparatus 100 may set the display starting position similarly to the case of displaying the contents data stored in the storage unit, but the invention is not limited thereto.

### Overview of Processes for Implementing Display Method According to Embodiment of the Invention

Next, the overview of the process in the display apparatus 100 for implementing the displaying method according to the embodiment of the invention is described.

### (1) Displaying-Number Determining Process

### (1-1) Displaying-Number Determining Process

The display apparatus 100 determines the displaying number of the contents data that are displayed on the display screen. Herein, in the display apparatus 100, for example, the number of the contents data input from the external apparatus 200 or the number of the contents data read from a storage unit (described later) of the display apparatus 100 may be defined as the displaying number, but the invention is not limited thereto. For example, the display apparatus 100 stores displaying number information defining the maximum value of the number of contents data displayed on the display screen. In the case where the number of contents data exceeds the displaying number defined by the displaying number information, the maximum value associated with the displaying number information may be the displaying number. Herein, the maximum value defined by the displaying number information may be, for example, defined in advance, but the invention is not limited thereto. For example, the display apparatus 100 may properly set the maximum value to the displaying number information in response to user's manipulation using a manipulator (described later) included in the display apparatus 100.

### (1-2) Contents Data Displaying Size Determining Process

In addition, display apparatus 100 determines a displaying size of the contents data displayed on the display screen based on the determined displaying number. In addition, the display apparatus 100 according to the embodiment of the invention may also be configured so as not to perform the process (1-2) (displaying size determining process). In the above case, for example, the display apparatus 100 displays the contents data displayed on the display screen with a predetermined displaying size that is not in accordance with the determined displaying number.

Hereinafter, the case where the display apparatus 100 according to the embodiment of the invention performs the process (1-2) (displaying size determining process) is exemplarily described.

### [A] First Displaying Size Determining Process

The display apparatus 100 stores, for example, a lookup table, in which the displaying numbers and the displaying sizes are listed in a correspondence manner. Next, the display apparatus 100 determines the displaying sizes corresponding to the displaying number determined in the process (1-1) by using the lookup table.

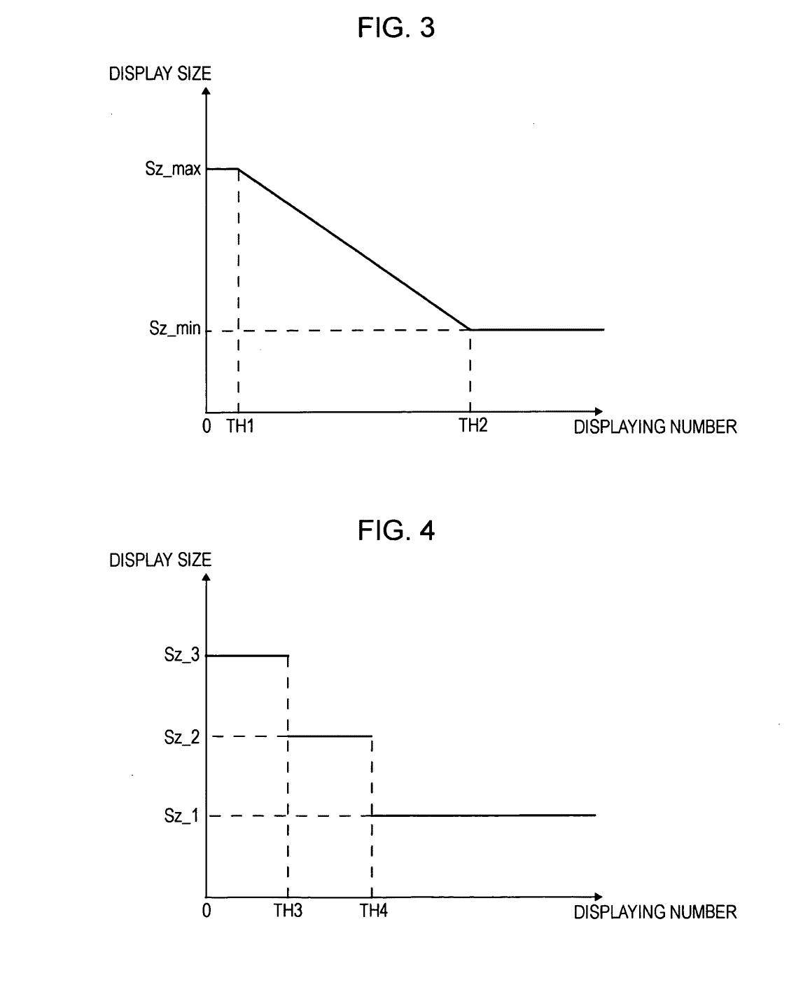

FIG. 3 is a first diagram illustrating a method of determining the displaying sizes of the contents data in the display apparatus 100 according to the embodiment of the invention. Herein, FIG. 3 illustrates an example of a value stored in the lookup table. In FIG. 3, Sz_min represents a minimum size of the displaying sizes of the contents data, and Sz_max represents a maximum size of the displaying sizes of the contents data. In addition, in FIG. 3, TH1 and TH2 represent examples of threshold values for setting each of the displaying sizes to the Sz_min or the Sz_max. As an example of the Sz_min, there is a size of an L format (89 mm×130 mm) of a picture, but the invention is not limited thereto. In addition, as an example of the Sz_max, there is a size of an LL format (127 mm×178 mm) of a picture, but the invention is not limited thereto.

For example, as shown in FIG. 3, by using the lookup table, in which the displaying numbers and the displaying sizes are listed in the correspondence manner, the display apparatus 100 may uniquely determine the displaying sizes corresponding to the displaying number determined in the process (1-1).

In addition, the method of determining the displaying sizes of the contents data according to the embodiment of the invention is not limited to the method using the lookup table, in which the information shown in FIG. 3 is recorded. FIG. 4 is a second diagram illustrating the method of determining the displaying sizes of the contents data in the display apparatus 100 according to the embodiment of the invention. Herein, FIG. 4 illustrates another example of the value stored in the lookup table. In FIG. 4, Sz_1 to Sz_3 represent the displaying sizes of the contents data. In FIG. 4, TH4 and TH5 represent examples of threshold values for setting each of the displaying sizes to one of the Sz_1 to the Sz_3. As an example of the Sz_1, there is a size of an L format (89 mm×130 mm) of a picture, and as an example of the Sz_3, there is a size of an LL format (127 mm×178 mm) of a picture, but the invention is not limited thereto. In addition, as an example of the Sz_3, one of the size of the L format and the size of the LL format may be arbitrarily set, but the invention is not limited thereto.

For example, even in the case where the lookup table, in which the information shown in FIG. 4 is recorded, is used, the display apparatus 100 may uniquely determine the displaying sizes corresponding to the displaying number determined in the process (1-1) similarly to the case of using the lookup table shown in FIG. 3.

### [B] Second Displaying Size Determining Process

In the aforementioned embodiment, as the first displaying size determining process, the displaying sizes corresponding to the displaying number determined in the process (1-1) may be uniquely determined. However, the displaying size determining process in the display apparatus 100 is not limited to the process of uniquely determining the displaying sizes corresponding to the displaying number determined in the process (1-1). For example, in addition to determining the displaying sizes by using the lookup table, the display apparatus 100 may change the displaying sizes of the contents data based on meta information that is further included in the contents data.

More specifically, for example, in the case where the information of “favorite contents data” is set to the meta information of the contents data, the display apparatus 100 sets a displaying size that is larger than the displaying size set by the lookup table. In addition, for example, in the case where the information of “displaying size” is set to the meta information of the contents data, the display apparatus 100 determines the displaying size set to the meta information as the displaying size of the contents data. In addition, the example of changing the displaying size of the contents data based on the meta information included in the contents data according to the embodiment of the invention is limited thereto.

The display apparatus 100 may determine the displaying size of the contents data by performing, for example, the process [a] or the process [b]. In addition, the display apparatus 100 records, for example, the determined displaying size as the displaying size information and displays the contents data based on the information of the displaying size. In addition, the method of storing the determined displaying size in the display apparatus 100 is not limited thereto.

### (2) Displaying Position Determining Process

In order to implement the displaying method shown in FIGS. 2B and 2C, the display apparatus 100 determines a position (for example, T in FIG. 2B, hereinafter, referred to as a “display starting position”) of starting the displaying of the contents data and a position (hereinafter, referred to as a “displaying position”) of displaying the contents data.

### (2-1) Display Starting Position Determining Process

The display apparatus 100 determines, for example, a position corresponding to the contents data input unit as a display starting position based on a position provided by the contents data input unit to which the contents data are input. Herein, the contents data input unit according to the embodiment of the invention denotes, for example, an element having a function of receiving the contents data stored in an external recording medium and/or a function of reading the contents data from the external recording medium.

### Example of Contents Data Input Unit

As an example of the contents data input unit having the function of receiving the contents data stored in the external recording medium, there is a USB port and a processing circuit, a LAN port and transceiving circuit, or an IEEE802.11b port and transceiving circuit, but the invention is not limited thereto. In addition, in the case where the contents data input unit has the function of receiving the contents data stored in the external recording medium, for example, a communication unit (described later) included in the display apparatus 100 may serve as the contents data input unit.

In addition, as an example of the contents data input unit having the function of reading the contents data from the external recording medium, there is a slot, in which the external recording medium such as a memory stick or a SD memory card may be detachably inserted, but the invention is not limited thereto. For example, the contents data input unit having the function of reading the contents data from the external recording medium may be an optical disk drive such as a Blu-ray (registered trade mark) disk drive or an opto-magnetic disk drive such as an MO (magneto-optical) disk drive. In addition, in the case where the contents data input unit has the function of reading the contents data from the external recording medium, for example, an external recording medium reading unit (described later) included in the display apparatus 100 may serve as the contents data input unit.

In addition, the contents data input unit according to the embodiment of the invention may include, for example, a function of receiving the contents data stored in the external recording medium and a function of reading the contents data from the external recording medium by using a device of a combination of the aforementioned examples.

The display apparatus 100 includes, for example, one or two or more contents data input units. In addition, the display apparatus 100 determines a position corresponding to the contents data input unit as a display starting position based on a position provided by the contents data input unit to which the contents data are input. Herein, in the case where the display apparatus 100 includes a plurality of the contents data input units, the display apparatus 100 may include different types of the contents data input units or a plurality of identical contents data input units.

In addition, in the above case, the contents data input unit is described to have the function of receiving the contents data stored in the external recording medium and/or the function of reading the contents data from the external recording medium, but the invention is not limited thereto. For example, in the display apparatus 100, a storage unit (described later) included in an inner portion of the display apparatus 100 capable of recording the contents data may be treated as the contents data input unit. In the above case, the display apparatus 100 may determine a position corresponding to the position provided by the storage unit as the display starting position. In addition, the display apparatus 100 may determine a predetermined position or a position set in response to user's manipulation using a manipulator (described later) as the display starting position.

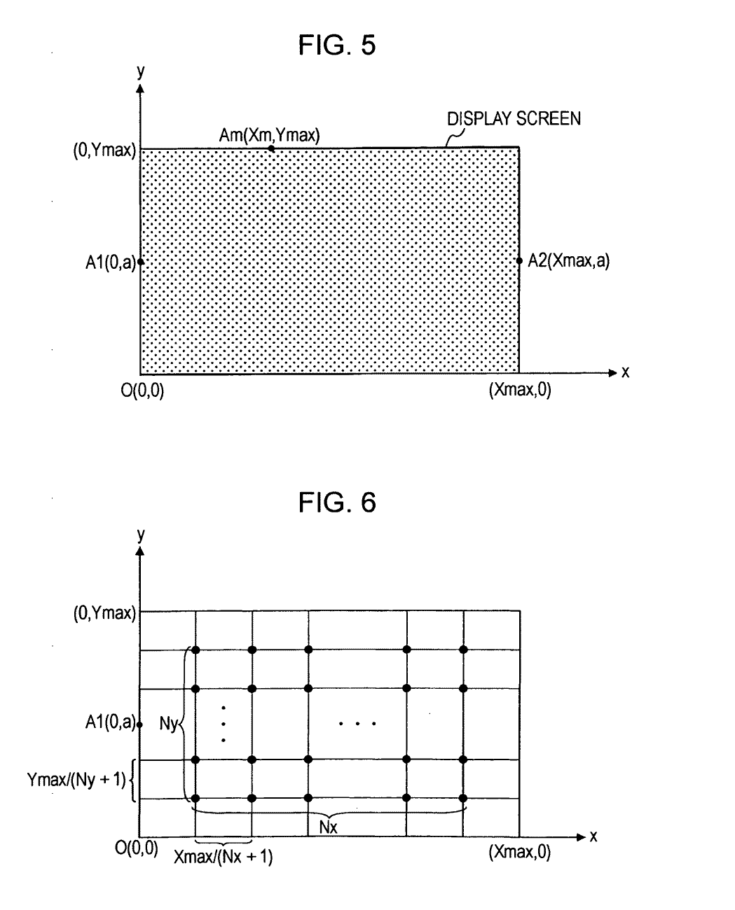

FIG. 5 is a diagram illustrating an example of the display starting position determined by the display apparatus 100 according to the embodiment of the invention. Herein, in FIG. 5, the left lower corner of the display screen of the display apparatus 100 represents the origin O, and the points of the display screen are represented by two-dimensional coordinates. Hereinafter, the points on the display screen of the display apparatus 100 are represented by two-dimensional coordinates or three-dimensional coordinates in the description thereof. In addition, in this case, similarly to FIG. 5, the origin is represented by the point at the left lower corner of the display screen in the description thereof. In addition, in the case where the points of the display screen are represented by the two-dimensional coordinates or the three-dimensional coordinates, the origin is not limited to the left lower corner.

The point Am (m is an integer of 1 or more) shown in FIG. 5 illustrates an example of the display starting position. For example, the display apparatus 100 stores, for example, the display starting position information of recording the coordinate corresponding to the position provided by the contents data input unit, and determines the display starting position corresponding to the contents data input unit, to which the contents data are input. In addition, the display starting position information further stores, for example, the coordinate set in response to the user's manipulation. In addition, the method of determining the display starting position in the display apparatus 100 is not limited to the method using the display starting position information.

### (2-2) Displaying Position Candidates Deriving Process

In order to determine the displaying positions, at which the contents data are displayed, the display apparatus 100 derives the candidates of the displaying positions (hereinafter, referred to as “displaying position candidates”), at which the contents data may be displayed.

### Examples of Method of Deriving Displaying Position Candidates

### A. First Example

### Method of Deriving Display Position Candidates Represented by Two-Dimensional Coordinates

First, a method of deriving the displaying position candidates represented by two-dimensional coordinates according to the embodiment of the invention is described.

The display apparatus 100 derives the coordinates (two-dimensional coordinates) of the displaying position candidates, for example, based on the displaying number determined in the process (1) (displaying-number determining process). FIG. 6 is a diagram illustrating a first example of the method of deriving the displaying position candidates in the display apparatus 100 according to the embodiment of the invention. Herein, FIG. 6 illustrates the case where the display starting position is set to the point A1 (0, a) (a is a positive integer satisfying 0<a<Ymax).

In addition, in FIG. 6, the x axis corresponds to the horizontal direction of the display screen, and the y axis corresponds to the vertical direction of the display screen. In addition, the point (Xmax, 0) of FIG. 6 represents the coordinate of the right lower corner of the display screen, and the point (0, Ymax) of FIG. 6 represents the coordinate of the left lower corner of the display screen. In other words, the aspect ratio of the display screen of the display apparatus 100 is expressed by “Xmax:Ymax”. In addition, hereinafter, it is set such that Xmax>Ymax in the description, but the invention is not limited thereto.

The display apparatus 100 derives the displaying position candidates, for example, in a matrix in a two-dimensional plane defined by the horizontal direction and vertical direction of the display screen, for example, based on the displaying number N (N is a positive integer) determined in the process (1). More specifically, the display apparatus 100 derives the (Nx×Ny) (Nx and Ny are positive integers) displaying position candidates satisfying a relationship expressed by the following Equation 1 for each displaying position candidate. Herein, in the display apparatus 100, the Nx and the Ny are set, for example, to satisfy the relationship that Nx≧Ny so as to correspond to the relationship of the aspect ratio of the picture represented by the contents data, but the invention is not limited thereto.

Nx×Ny≧N (Equation 1)

In other words, the display apparatus 100 derives the coordinate of the displaying position candidates by deriving Nx and Ny satisfying Equation 1. Hereinafter, an example of a method of deriving the Nx and the Ny according to the embodiment of the invention is described. In addition, hereinafter, in the display apparatus 100, a method of deriving the Nx and the Ny satisfying the following Equation 2 is exemplarily described, but the method of deriving the Nx and the Ny according to the embodiment of the invention is not limited thereto.

Xmax:Ymax=Nx:Ny (Equation 2)

From Equation 2, the Ny is expressed by the following Equation 3.

Ny=(Ymax/Xmax)·Nx (Equation 3)

Herein, by substituting Equation 3 to Equation 1, Equation 1 becomes Equation 4.

(Ymax/Xmax)·Nx²≧N (Equation 4)

Therefore, the display apparatus 100 derives, for example, the minimum of the Nx satisfying Equation 4. In other words, by deriving the minimum of the Nx satisfying the following Equation 5, the display apparatus 100 may determine the Nx.

Nx=\sqrt{(Ymax/Xmax)·N} (Equation 5)

In addition, the display apparatus 100 may derive the Ny, for example, by substituting the Nx derived by using Equation 5 to Equation 3.

The display apparatus 100 may determine the coordinates (two-dimensional coordinates) of the (Nx×Ny) displaying position candidates for each displaying position candidate, for example, based on the Nx and Ny derived by using the aforementioned Equations 1 to 5.

### B. Second Example

### Method of Deriving Display Position Candidates Represented by Three-Dimensional Coordinates

In the aforementioned example, as the first example of the method of deriving the displaying position candidates according to the embodiment of the invention, the method of deriving the displaying position candidates represented by two-dimensional coordinates is described. However, the method of deriving the displaying position candidates according to the embodiment of the invention is not limited to the method of deriving the displaying position candidates represented by the two-dimensional coordinates. Next, as the first example of the method of deriving the displaying position candidates according to the embodiment of the invention, an example of the deriving method in the case where the display apparatus 100 derives the displaying position candidates represented by three-dimensional coordinates is described.

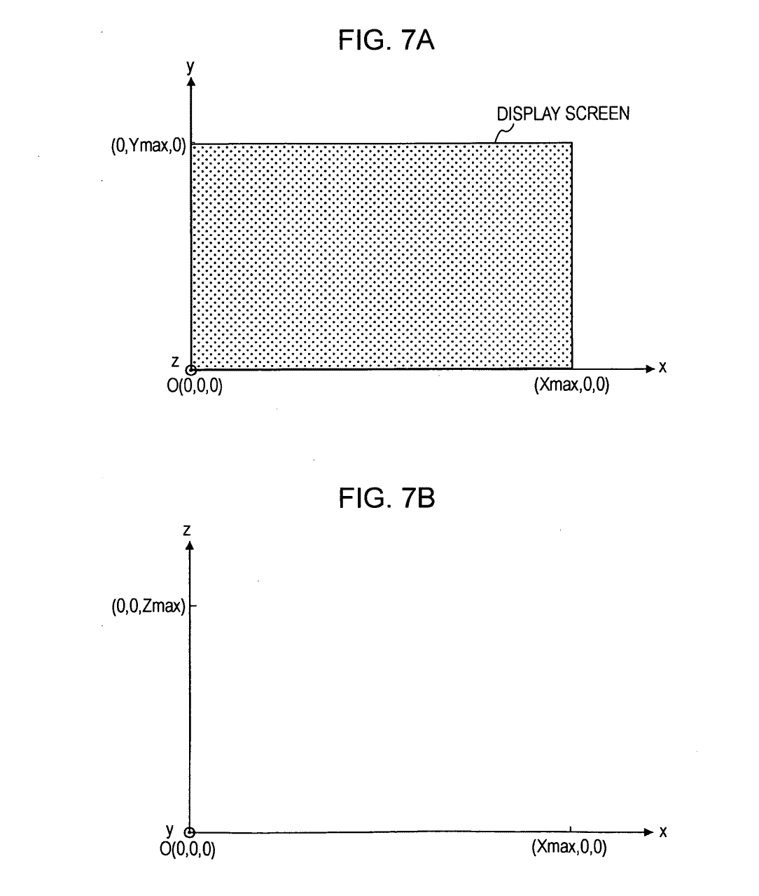

FIGS. 7A and 7B are diagrams illustrating a second example of the method of deriving the displaying position candidates in the display apparatus 100 according to the embodiment of the invention. Herein, in FIGS. 7A and 7B, the x axis corresponds to the horizontal direction of the display screen, and the y axis corresponds to the vertical direction of the display screen. In addition, in FIGS. 7A and 7B, the z axis corresponds to the perpendicular direction with respect to the display screen. In the display apparatus 100, a user's side of the view of the display screen is defined as the positive z axis direction, but the invention is not limited thereto. Hereinafter, in the description, the user's side of the view of the display screen is defined the positive z axis direction.

In addition, similarly to FIG. 6, the point (Xmax, 0, 0) of FIGS. 7A and 7B represents a coordinate of the right lower corner of the display screen, and similarly to FIG. 6, the point (0, Ymax, 0) of FIG. 7A represents a coordinate of the left upper corner of the display screen. In addition, the Zmax shown in FIG. 7B represents a maximum value in the z axis direction set in the display apparatus 100. The display apparatus 100 derives the displaying position candidates in a three-dimensional space defined by the horizontal direction and the vertical direction of the display screen and the perpendicular direction (more specifically, Zmax) with respect to the display screen based on the displaying number N (N is a positive integer) determined by the aforementioned process (1).

Similarly to the first example of the method of deriving the displaying position candidates, the display apparatus 100 determines the x coordinate and y coordinate of each of the displaying position candidates based on the Nx and the Ny derived from the Equations 1 to 5.

In addition, the display apparatus 100 derives the value of the z coordinate of each of the displaying position candidates based on the value of the x coordinate (hereinafter, simply referred to as “x”) and the value of the y coordinate (hereinafter, simply referred to as “y”) of each of the determined displaying position candidates.

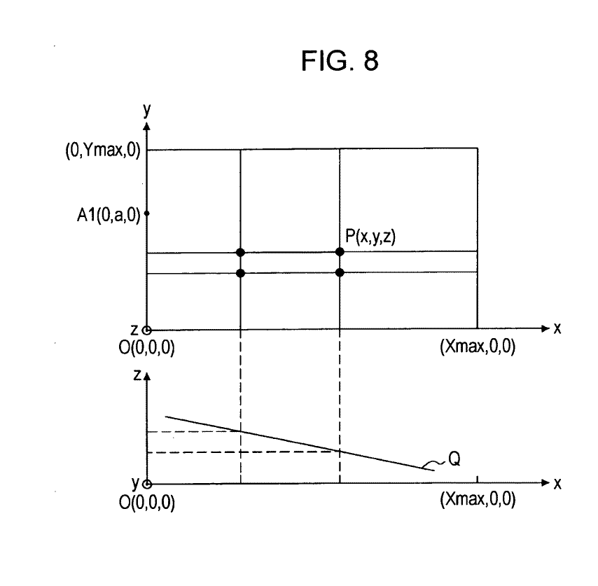

FIG. 8 is a diagram illustrating the second example of the method of deriving the displaying position candidates in the display apparatus 100 according to the embodiment of the invention. Herein, FIG. 8 illustrates an example of the method of deriving the value of the z coordinate of the displaying position candidate. In addition, FIG. 8 illustrates the case where the display starting position is set to the point A1 (0, a, 0).

The display apparatus 100 derives the value of the z coordinate of each of the displaying position candidates so that the value of the z coordinate of the displaying position candidate is, for example, reversely proportional to a distance from the display starting position in the z axis direction. More specifically, the display apparatus 100 derives the value of the z coordinate of each of the displaying position candidates by substituting the value of the x coordinate and the value of the y coordinate of each of the determined displaying position candidates to the following Equation 6 corresponding to the Q of FIG. 8. Herein, the following Equation 6 expresses the case where the display starting position is the point A1 (0, Ymax, 0).

$$z = f ( x , y ) = \frac{1}{\sqrt{{x}^{2} + {( y - a )}^{2 }}} \qquad ( Equation 6 )$$

The display apparatus 100 may determine the coordinates (three-dimensional coordinates) of (NxxNy) displaying position candidates for each displaying position candidate, for example, by using Equations 1 to 6.

The display apparatus 100 may derive the coordinates (two-dimensional coordinates/three-dimensional coordinates) of the (Nx×Ny) displaying position candidates for each displaying position candidate, for example, by using the methods according to the first and second examples. In addition, the method of deriving the displaying position candidate according to the embodiment of the invention is not limited thereto.

### (2-3) Displaying Position Determining Process

If the displaying position candidates are derived in the process (2-2) (displaying position candidate deriving process), the display apparatus 100 selects N displaying position candidates among the (Nx×Ny) displaying position candidates at random. Herein, the selected displaying position candidates become the displaying positions, at which the contents data are disposed. In other words, the display apparatus 100 sets the displaying positions of the number corresponding to the displaying number determined in the process (1-1) (displaying-number determining process).

In addition, the displaying position determining method in the display apparatus 100 is not limited to the above method. For example, the display apparatus 100 may perform selection with weighting factors so that much more displaying position candidates in the vicinity of the center of the display screen are selected among the (Nx×Ny) displaying position candidates. In addition, the display apparatus 100 may remove the displaying position candidates, at which the entire contents data may not be displayed inside the display screen and determine the displaying positions, for example, based on the information regarding the displaying sizes set in the contents data. According to the determining method, the display apparatus 100 may prevent the occurrence of the displaying result where some contents data to be displayed on the display screen are not included inside the display screen.

### (3) Displaying Process

If the display starting position and the displaying positions are determined in the process (2) (displaying position determining process), the display apparatus 100 allows the contents data to be moved from the display starting position toward the displaying positions so as to be displayed. Hereinafter, an example of the displaying process in the display apparatus 100 is described.

### Examples of Displaying Process

### A. First Example

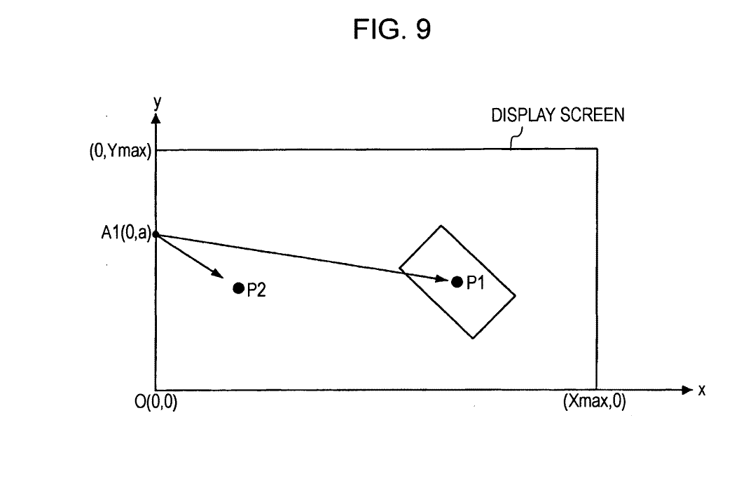

In the case where the display starting position and the displaying positions are represented by two-dimensional coordinates, FIG. 9 is a diagram illustrating a first example of the displaying process in the display apparatus 100 according to the embodiment of the invention. Herein, FIG. 9 illustrates a case where the display starting position is A1 (0, a) and two points P1 and P2 are selected as the displaying positions. In other words, FIG. 9 illustrates an example of the case where the display starting position and the displaying positions are represented by two-dimensional coordinates.

The display apparatus 100 displays the contents data, for example, in the order from the displaying position having a long distance from the display starting position (in FIG. 9, in the order of the point P1 and the point P2), but the invention is not limited thereto. For example, the display apparatus 100 may display the contents data, for example, in the order from the displaying position having a short distance from the display starting position (in FIG. 9, in the order of the point P2 and the point P1).

Herein, the display apparatus 100 allows the contents data to be moved so as to be displayed so that the central position of the contents data is coincident with the displaying position, but the invention is not limited thereto. In addition, the display apparatus 100 may implement the displaying by allow the contents data to be moved by changing the values of the x coordinate and the y coordinate of the central position of the contents data by predetermined values, but the invention is not limited thereto. In addition, the display apparatus 100 may display the contents data, for example, by setting random angles (for example, angles with respect to the horizontal direction of the display screen) to the contents data.

In addition, the display apparatus 100 displays the contents data according to the order in which the contents data to be displayed on the display screen are input to the contents data input unit, but the invention is not limited thereto. For example, in the case where information indicating the “favorite contents data” is set to meta information of the contents data, the display apparatus 100 may change the order of displaying the contents data, to which the information indicating the “favorite contents data” is set. As an example of the method of change the order of displaying, there is, for example, a method of displaying the contents data, to which the information indicating the “favorite contents data” is set, in the prior order or a method of displaying the contents data, to which the information in is set, in the later order, but the invention is not limited thereto.

In addition, in the case where the displayed contents data are overlapped, the display apparatus 100 allow the overlapping portion of the contents data displayed in the later order to be displayed, but the invention is not limited thereto. For example, in the case where the information indicating the “favorite contents data” is set to the meta information of the contents data, the display apparatus 100 may display the entire contents data set to the information indicating the “favorite contents data”. In addition, in the case where the contents data set to the information indicating the “favorite contents data” are overlapped, the display apparatus 100 may display the overlapped portion based on the method of displaying the contents data.

In the case where the display starting position and the displaying positions are represented by two-dimensional coordinates, the display apparatus 100 displays the contents data, for example, in the aforementioned manner.

### B. Second Example

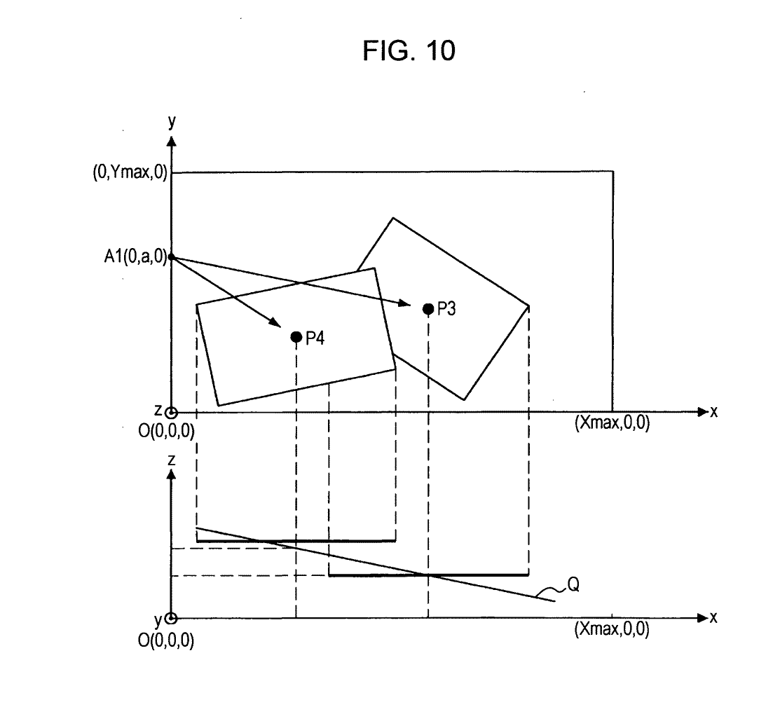

In the case where the display starting position and the displaying positions are represented by three-dimensional coordinates, FIG. 10 is a diagram illustrating a second example of the displaying process in the display apparatus 100 according to the embodiment of the invention. Herein, FIG. 10 illustrates an example where the display starting position is A1 (0, a, 0) and two points P3 and P4 are selected as the displaying positions. In other words, FIG. 10 illustrate an example of the case where the display starting position and the displaying positions are represented by three-dimensional coordinates.

Similarly to the case where the display starting position and the displaying positions are represented by two-dimensional coordinates, the display apparatus 100 displays the contents data, for example, in the order from the displaying position having a long distance from the display starting position (in FIG. 10, in the order of the point P3 and the point P4). Herein, similarly to the case where the display starting position and the displaying positions are represented by two-dimensional coordinates, the display apparatus 100 allows the contents data to be moved so as to be displayed so that the central position of the contents data is coincident with the displaying position, but the invention is not limited thereto.

In addition, in the case where the display starting position and the displaying positions are represented by three-dimensional coordinates, as shown in FIG. 10, for example, as the distance from the display starting position is longer, the overlapped portion in the contents data disappears, but the invention is not limited thereto. For example, in the case where the information indicating the “favorite contents data” is set to the meta information of the contents data, the display apparatus 100 may display the entire contents data, to which the information indicating the “favorite contents data” is set, irrespective of the value of the set z axis coordinate.

In the case where the display starting position and the displaying positions are represented by three-dimensional coordinates, the display apparatus 100 displays the contents data, for example, in the aforementioned manner.

The display apparatus 100 allows the contents data to be moved, for example, from the display starting position to the displaying positions to be displayed as shown in the first and second examples. Therefore, for example, the displaying method according to the embodiment of the invention shown in FIGS. 2A to 2C is implemented. In addition, the displaying process in the display apparatus 100 is not limited to the first example or the second example.

### Other Display Examples in Display Apparatus 100

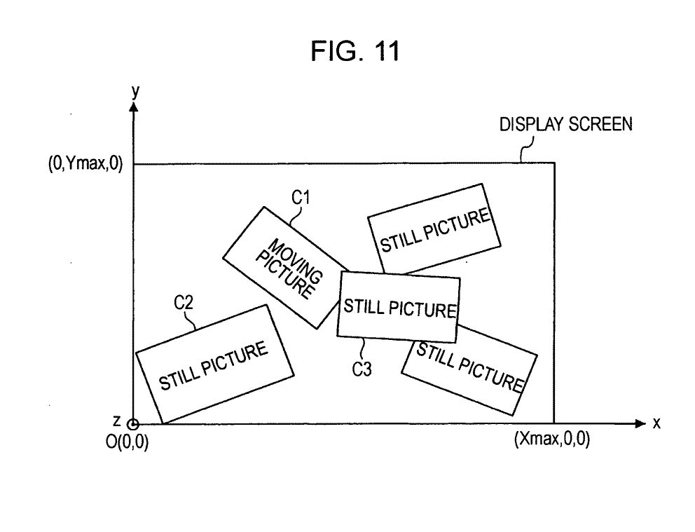

FIG. 11 is a diagram illustrating another example of displaying the contents data on the display screen of the display apparatus 100 according to the embodiment of the invention. Herein, FIG. 11 illustrates another example of the state in which the display apparatus 100 displays the contents data on the display screen.

As shown in FIG. 11, the display apparatus 100 may display on the display screen a mixture of the contents data representing still pictures and the contents data representing moving pictures (for example, C1 of FIG. 11. Herein, the display apparatus 100 displays the picture, for example, represented by the front frame of the moving picture. In addition, for example, in the case where the contents data representing the moving picture by user's manipulation using a manipulator (described later) of the display apparatus 100 are selected, the reproduction of the moving picture is configured to start in the state represented in the tabular format as shown in FIG. 11. In addition, in the case where the contents data are selected by user's manipulation, the display apparatus 100 may display the moving picture corresponding to the contents data, for example, in the entire screen displaying manner.

In addition, as shown in FIG. 11, the display apparatus 100 may display contents data (for example, C2 in FIG. 11) different from the contents data having different displaying sizes. In addition, similarly to the contents data shown in C3 of FIG. 11, the display apparatus 100 may display, for example, the entire contents data irrespective of the order of displaying the contents data.

The display apparatus 100 may implement the displaying method according to the embodiment of the invention, for example, shown in FIGS. 2A to 2C and FIG. 11, for example, by using the process (1) (displaying-number determining process), the process (2) (displaying position determining process), and the process (3) (displaying process).

Therefore, by using the processes (1) to (3), the display apparatus 100 intuitive displaying so that the user more easily view the contents data in the case where a plurality of the contents data is displayed on the display screen. In addition, by using the processes (1) to (3), the display apparatus 100 may more effectively display the contents data to the user than the case of using the displaying method in the related art.

### Detailed Examples of Process in Display Apparatus 100

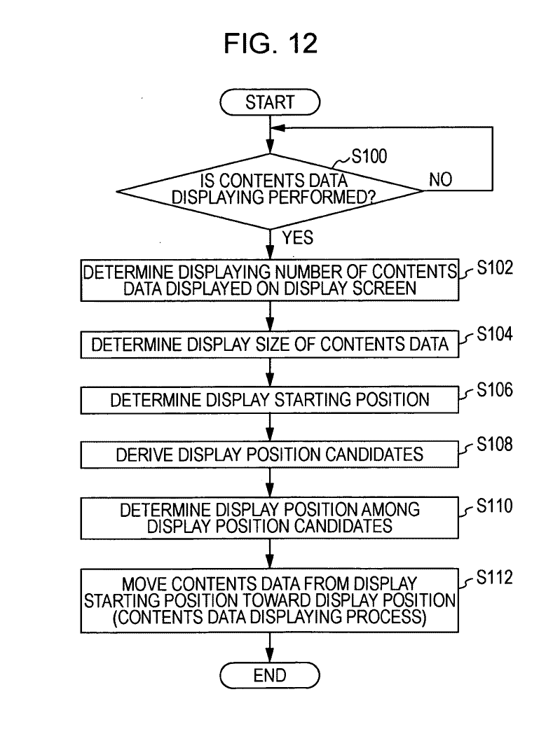

Next, a process for implementing the displaying method according to the embodiment of the invention in the display apparatus 100 is described in detail. FIG. 12 is a flowchart illustrating an example of the process in the process apparatus 100 according to the embodiment of the invention.

The display apparatus 100 determines whether or not the displaying of the contents data is performed (S100). Herein, the display apparatus 100 performs the determination of Step S100, for example, based on whether or not the contents data is input to the contents data input unit, but the invention is not limited thereto. In the case where the displaying of the contents data is not determined in Step S100, the display apparatus 100 does not perform the process until the displaying of the contents data is determined to be performed.

In addition, in the case where the displaying of the contents data is determined to be performed in the Step S100, the displaying number of the contents data displayed on the display screen is determined (S102). Herein, for example, the number of the contents data input based on the contents data input to the contents data input unit in the display apparatus 100 is defined as the displaying number, but the invention is not limited thereto.

If the displaying number is determined in Step S102, the display apparatus 100 determines the displaying number of the contents data (S104). Herein, the display apparatus 100 determines the displaying sizes corresponding to the determined displaying number by using a lookup table, in which the displaying numbers determined in Step S102, the displaying numbers shown in FIGS. 3 and 4 and the displaying sizes are listed in a correspondence manner, but the invention is not limited thereto.

The display apparatus 100 determines a display starting position (S106). Herein, the display apparatus 100 determines the position provided by the contents data input unit to which the contents data are input and the display starting position based on the display starting position information, but the invention is not limited thereto. In addition, in the case where a plurality of the contents data input units input with the contents data exist, the display apparatus 100 may set a plurality of the display starting positions.

In addition, in FIG. 12, an example of performing the process of Step S104 and, after that, performing the process of Step S106 are illustrated, but the invention is not limited thereto. For example, the display apparatus 100 may independently perform the process of Step S102, the process of S104, and the process of Step S106. Therefore, the display apparatus 100 may perform the process of Step S106 and, after that, the process of Step S102 and the process of S104. In addition, the process of Step S102, the process of S104, and the process of S106 may be configured to start in a synchronization manner.

The display apparatus 100 derives the displaying position candidates (S108). Herein, the display apparatus 100 derives the displaying position candidates, for example, by performing the calculations of the Equations 1 to 5 (or Equations 1 to 6), for example, based on the displaying number determined in Step S102, but the invention is not limited thereto.

In addition, in FIG. 12, an example of performing the process of Step S106 and, after that, performing the process of Step S108 is illustrated, but the invention is not limited thereto. For example, since the display apparatus 100 derives the displaying position candidates based on the displaying number determined in the process of Step S102, the process of Step S108 may be performed at an arbitrary timing after the process of Step S102 is completed.

If the displaying position candidates are derived in the Step S108, the display apparatus 100 determines displaying positions of the number corresponding to the displaying number among the derived displaying position candidates (S110). Herein, the display apparatus 100 determines the displaying positions, for example, by selecting the displaying position candidates of the number corresponding to the displaying number among the derived displaying position candidates, but the invention is not limited thereto.

If the display starting position is determined in Step S106 and if the displaying positions are determined in Step S110, the display apparatus 100 allows the contents data to be moved from the display starting position toward the displaying positions (S112; contents data displaying process).

The display apparatus 100 implements the process (1) (displaying-number determining process), the process (2) (displaying position determining process), and the process (3) (displaying process), for example, by performing the process shown in FIG. 12. Therefore, by performing the process shown in FIG. 12, the display apparatus 100 may implement intuitive displaying so that the user more easily view the contents data in the case where a plurality of the contents data is displayed on the display screen. In addition, by performing the process shown in FIG. 12, the display apparatus 100 may more effectively display the contents data to the user than the case of using the displaying method in the related art.

### Display Apparatus According to Embodiment of the Invention

Next, an example of a configuration of the display apparatus 100 according to the embodiment of the invention capable of implementing the displaying method according to the embodiment of the invention is described.

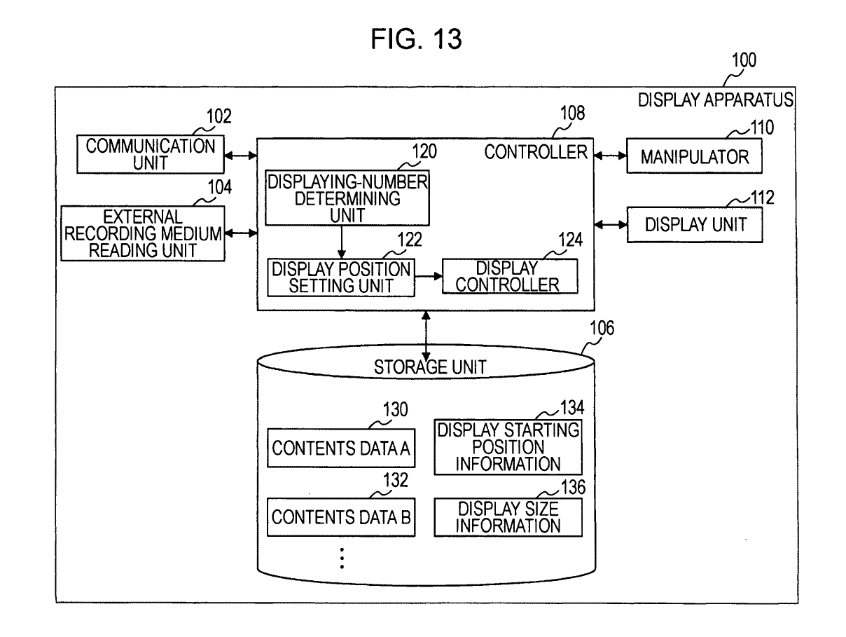

FIG. 13 is a diagram illustrating an example of a configuration of the display apparatus 100 according to the embodiment of the invention. The display apparatus 100 includes a communication unit 102, an external recording medium reading unit 104, a storage unit 106, a controller 108, a manipulator 110, and a display unit 112.

In addition, the display apparatus 100 may includes, for example, a ROM (read only memory; not shown) or a RAM (random access memory; not shown). In the display apparatus 100, the components are connected, for example, a bus as a date transmission line. Herein, the ROM stores programs used by the controller 108 or control data such as calculation parameters. The RAM primarily stores the programs executed by the controller 108.

### Example of Hardware Configuration of Display Apparatus 100

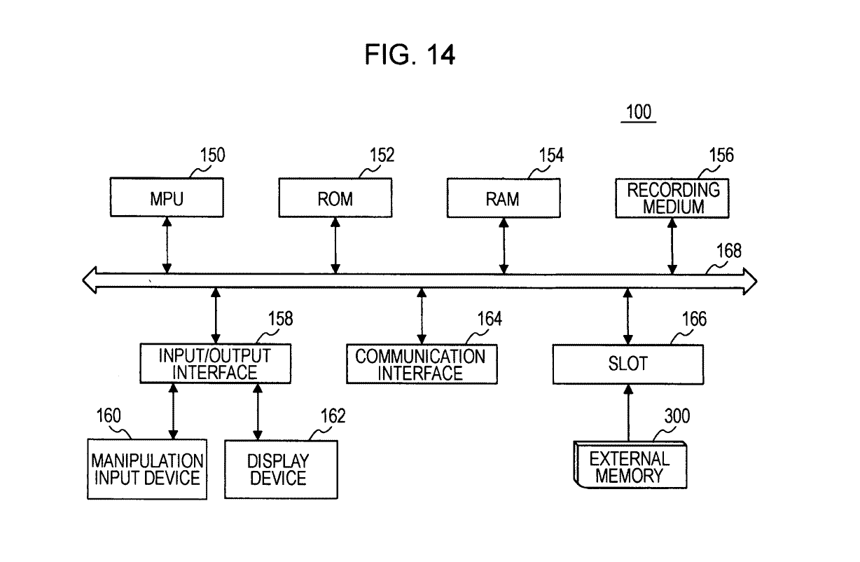

FIG. 14 is a diagram illustrating an example of a hardware configuration of the display apparatus 100 according to the embodiment of the invention. In FIG. 14, as an example of the external recording medium, an external memory 300 is also shown. Herein, as an example of the external memory 300, there is a memory stick or an SD memory card, but the invention is not limited thereto.

The MPU 150 is constructed with an integrated circuit, in which a plurality of circuits are integrated, for implementing MPU or a control function to function as a controller 108 of controlling the entire display apparatus 100. In addition, the MPU 150 may serve as the later-described displaying-number determining unit 120, the displaying position setting unit 122, and the display controller 124 in the display apparatus 100.

The ROM 152 stores programs used by the MPU 150 or control data such as calculation parameters. In addition, the RAM 154 primarily stores the programs, for example, executed by the MPU 150.

The recording medium 156 functions as the storage unit 106 to stores, for example, various types of data (information) such as the display starting position information, the displaying size information, the contents data, and applications. Herein, as an example of the recording medium 156, there is a magnetic recording medium such as a hard disk or a non-volatile memory such as an EEPROM (electrically erasable and programmable read only memory), a flash memory, an MRAM (magneto-resistive random access memory), an FeRAM (ferroelectric random access memory), and a PRAM (phase change random access memory), but the invention is not limited thereto.

The input/output interface 158 connects, for example, a manipulation input device 160 or a display device 162. The manipulation input device 160 functions as the manipulator 110, and the display device 162 functions as the display unit 112. Herein, as an example of the input/output interface 158, there is a USB port, a DVI (digital visual interface) port, an HDMI (high-definition multimedia interface) ports, or various circuits, but the invention is not limited thereto. In addition, the manipulation input device 160 is, for example, provided on the display apparatus 100 to be connected to the input/output interface 158 in the inner portion of the display apparatus 100. AS an example of the manipulation input device 160, there is a button, an arrow key, a rotation type selector such as a jog dial, or a combination thereof, but the invention is not limited thereto. In addition, the display device 162 is, for example, provided on the display apparatus 100 to be connected to the input/output interface 158 in the inner portion of the display apparatus 100. As an example of the display device 162, there is an LCD, an organic EL display (organic electro-luminescence display), or an OLED display (organic light emitting diode display), but the invention is not limited thereto. In addition, the input/output interface 158 may be connected to a manipulation input device (for example, keyboard or mouse) or a display device (for example, an external display) as the external apparatus of the display apparatus 100.

In addition, as shown in FIGS. 2A to 2C, the input/output interface 158 is connected to the external apparatus, so that the input/output interface 158 may receive the contents data that are transmitted from the connected external apparatus. In other words, in the display apparatus 100, the input/output interface 158 may function as the communication unit 102 of communicating with the external apparatus, and the input/output interface 158 may serves as the contents data input unit, to which the contents data recorded in the external apparatus are input.

The communication interface 164 is a communication section included in the display apparatus 100 and functions as the communication unit 102 for communicating with the external apparatus via a network (or, directly) in a wireless/wired manner. Herein, as an example of the communication interface 164, there is a communication antenna, an RF circuit (radio communication), an IEEE802.15.1 port and a transceiving circuit (radio communication), an IEEE802.11b port and a transceiving circuit (radio communication), or a LAN port and a transceiving circuit (cable communication), but the invention is not limited thereto. In addition, in the display apparatus 100, the communication interface 164 serves as the contents data input unit that receives the contents data (is input with the contents data) that are transmitted from the external apparatus via a network (or, directly).

The slot 166 has an opening of inserting a detachable external memory (an example of the external recording medium) to detachably receive the external memory 300 and read from the external memory 300 the data (information) recorded in the external memory 300. Therefore, the slot 166 functions as the external recording medium reading unit 104 of reading the data recorded in the external recording medium in the display apparatus 100. In addition, in the case where the contents data are recorded in the inserted external memory 300, the slot 166 may read the contents data. In other words, the slot 166 serves as the contents data input unit, to which the contents data recorded in the external memory 300 in the display apparatus 100 are input. In addition, the slot 166 is not limited to the configuration of reading the data from the inserted external memory 300, but the slot 166 may have the configuration of, for example, recording the data in the external memory 300. Herein, as an example of the external memory 300 inserted into the slot 166, there is a memory stick or an SD memory card, but the invention is not limited thereto. In addition, the slot 166 may be configured as a multi-slot according to a plurality of external memory standards.

In addition, in FIG. 14, the display apparatus 100 has the configuration of receiving one external memory 300, but the invention is not limited thereto. For example, the display apparatus 100 according to the embodiment of the invention may include a plurality of slots to detachably receive a plurality of external memories. In addition, the display apparatus 100 may have a slot capable of receiving a plurality of the external memories.

By using the configuration shown in FIG. 14, the display apparatus 100 implements the process (1) (displaying-number determining process), the process (2) (displaying position determining process), and the process (3) (displaying process).

In addition, the hardware configuration of the display apparatus 100 according to the embodiment of the invention is not limited to the configuration shown in FIG. 14. For example, the display apparatus 100 may further include an optical disk drive (not shown) capable of reading the data from an optical disk as the external recording medium and an audio output device (not shown) constructed with a DSP (digital signal processor), an amplifier, a speaker, and the like. In addition, the display apparatus 100 may include an optical disk drive (not shown) instead of the slot 166. In the above case, the optical disk drive (not shown) serves as the contents data input unit, to which the contents data recorded in the optical disk in the display apparatus 100 are input. Herein, as an example of the optical disk drive 168, there is a drive having a function of reading the optical disk such as a Blu-ray (registered trade mark) disk drive or a dive having functions of reading and writing such as a DVD-R drive, but the invention is not limited thereto.

Next, the components of the display apparatus are described with reference to FIG. 13. The communication unit 102 is a communication section included in the display apparatus 100 to communicate with an external apparatus via a network (or, directly) in a wireless/wired manner. Since the display apparatus 100 includes the communication unit 102, the display apparatus 100 may receive the contents data that are transmitted from the external apparatus. Therefore, the communication unit 102 serves as the contents data input unit that receives the contents data (are input with the contents data) that are transmitted from the external apparatus via the network (or, directly). In addition, the communication between the communication unit 102 and the external apparatus is controlled, for example, by a controller 108. Herein, as an example of the communication unit 102, there is a communication interface 164 or an input/output interface 158, but the invention is not limited thereto.

The external recording medium reading unit 104 reads from the external recording medium the data recorded in the external recording medium. Since the display apparatus 100 includes the external recording medium reading unit 104, the display apparatus 100 may read the contents data recorded in the external recording medium. Therefore, the external recording medium reading unit 104 serves as the contents data input unit, to which the contents data recorded in the external recording medium are input.

The storage unit 106 is a storage section included in the display apparatus 100. Herein, as an example of the storage unit 106, there is a magnetic recording medium such as a hard disk or a non-volatile memory such as a flash memory, but the invention is not limited thereto.

In addition, the storage unit 106 stores, for example, various data (information) such as the display starting position information, the displaying size information, the contents data, and the applications. Herein, in FIG. 13, the contents data such as contents data A 130 and contents data B 132, the display starting position information 134, and the displaying size information 136 are stored in the storage unit 106, but the invention is not limited thereto.

In addition, the contents data stored in the storage unit 106 are read, for example, by the controller 108. Herein, the display apparatus 100 may treat the reading of the contents data stored in the storage unit 106, for example, as the input of the contents data. In other words, the display apparatus 100 may perform the process (1) (displaying-number determining process) to the process (3) (displaying process), for example, based on the contents data stored in the storage unit 106. In the above case, the display apparatus 100 determine, for example, a predetermined position or a position set by user's manipulation as the display starting position, but the invention is not limited thereto.

The controller 106 is configured with, for example, an MPU and an integrated circuit in which various processing circuits are integrated to control the entire display apparatus 100. In addition, the controller 108 includes a displaying-number determining unit 120, a displaying position setting unit 122, and a display controller 124, to initiatively perform the process (1) (displaying-number determining process) to the process (3) (displaying process).

The displaying-number determining unit 120 serves to perform a portion of the process (1) (displaying-number determining process). More specifically, the displaying-number determining unit 120 serves to perform the process (1-1) (displaying-number determining process) to determine the displaying number of the contents data displayed on the display screen. Next, the displaying-number determining unit 120 transmits the information on the determined displaying number to the displaying position setting unit 122.

In addition, the displaying-number determining unit 120 may have the configuration capable of further performing the process (1-2) (contents data displaying size determining process). In the aforementioned case, the displaying-number determining unit 120 serves to perform the process (1) (displaying-number determining process). Hereinafter, the case where the process (1-2) (contents data displaying size determining process) is performed by the displaying position setting unit 122 is described.

The displaying position setting unit 122 serves to perform a portion of the process (1) (displaying-number determining process) and the process (2) (displaying position determining process).

More specifically, the displaying position setting unit 122 sets the displaying sizes of the contents data to be displayed, for example, based on the displaying number information transmitted from the displaying-number determining unit 120. In addition, the displaying position setting unit 122 may set the displaying sizes of the contents data based on the meta information included in the contents data.

In addition, the displaying position setting unit 122 performs the determining of the display starting position based on the position of the contents data input unit input with the contents data, the deriving of the displaying position candidates based on the displaying number information transmitted from the displaying-number determining unit 120, and the determining of the displaying positions.

The display controller 124 serves to perform the process (3) (displaying process). More specifically, the display controller 124 allows the contents data to be moved from the display starting position toward the displaying positions so as to be displayed on the display screen based on the display starting position and the displaying positions determined by the displaying position setting unit 122.

Since the controller 108 includes the displaying-number determining unit 120, the displaying position setting unit 122, and the display controller 124, the controller 108 may serve to initiatively perform the processes (1) to (3).

The manipulator 110 is a manipulation section included in the display apparatus 100, by which the user perform manipulation. Since the display apparatus 100 includes the manipulator 110, the user may perform desired processes such as selective reproduction of the contents data displayed on the display screen or reading of the contents data from the external apparatus or the external recording medium. Herein, the selective reproduction of the contents data denotes, for example, staring of reproduction of moving pictures or entire screen displaying, but the invention is not limited thereto. In addition, as an example of the manipulator 108, there is a button, an arrow key, a rotation type selector such as a jog dial, or a combination thereof, but the invention is not limited thereto.

The display unit 112 is a display section included in the display apparatus 100 to display various types of information on the display screen. As an example of the screen displayed on the display screen of the display unit 112, there is a display screen for a plurality of the contents data shown in FIGS. 2B and 2C or a manipulation screen for allowing the display apparatus 100 to perform the entire screen displaying of the contents data or desired operations on the contents data. Herein, as an example of the display unit 112, there is an LCD or an organic EL display, but the invention is not limited thereto. For example, in the display apparatus 100, the display unit 112 may be constructed with a touch screen. In the aforementioned case, the display unit 112 functions as a manipulation display unit capable of allowing user's manipulation and displaying.

The display apparatus 100 implements the process (1) (displaying-number determining process), the process (2) (displaying position determining process), and the process (3) (displaying process), for example, by using the configuration shown in FIG. 13. Therefore, the display apparatus 100 may implement intuitive displaying so that the user may more easily view the contents data in the case where a plurality of the contents data is displayed on the display screen. In addition, the display apparatus 100 may more effectively display the contents data to the user than the case of using the displaying method in the related art.

In this manner, the display apparatus 100 according to the embodiment of the invention displays a plurality of the contents data on the display screen by performing the process (1) (displaying-number determining process), the process (2) (displaying position determining process), and the process (3) (displaying process). Herein, as shown in FIGS. 2A to 2C, the display apparatus 100 allows the contents data to be moved, for example, from the position provided by the contents data input unit to which the contents data are input toward the displaying positions of the contents data set on the display screen so as to be displayed. Therefore, by using the displaying method according to the embodiment of the invention shown in FIGS. 2A to 2C, the display apparatus 100 may implement more intuitive display than the displaying method in the related art. In addition, at the time of displaying a plurality of the contents data, the display apparatus 100 forms, for example, a visual state in which physical pictures are simply spread out on a desk, so that a feeling that the user is “dealing with pictures” is provided to the user in comparison with the displaying method in the related art. In addition, as shown in FIG. 1C, in the displaying method in the related art, the displayed state of the contents data is uniform. However, as shown in FIG. 2C, in the display apparatus 100, the displayed state of the contents data is not uniform. Therefore, in comparison with the case where the displaying method in the related art is used, the display apparatus 100 may raise user's awareness of the contents data displayed on the display screen. Therefore, the display apparatus 100 may implement intuitive displaying so that the user may more easily check the contents data in the case where a plurality of the contents data is displayed on the display screen. In addition, the display apparatus 100 may more effectively display the contents data to the user than the case of using the displaying method of the contents data in the related art.

Hereinbefore, the embodiments of the invention are described with the display apparatus 100 exemplified, but the embodiments of the invention are not limited to the aforementioned embodiments. The embodiment of the invention may be adapted to, for example, a digital photo frame, a computer such as a notebook computer, a portable communication apparatus such as a mobile phone or a PHS (personal handy phone system), a video/audio playing apparatus such as WALK MAN (registered trade mark), a portable game machine such as Play Station Portable (registered trade mark), a television set capable of digital broadcasting/analog broadcasting, or various types of apparatuses capable of displaying the contents data.

### Program According to Embodiment of the Invention

According to the programs executed by a computer to function as the display apparatus according to the embodiment of the invention, intuitive displaying may be implemented so that the user more easily view the contents data in the case where a plurality of the contents data is displayed on the display screen. In addition, according to the programs of allowing the computer to function as the display apparatus according to the embodiment of the invention, the contents data may be more effectively displayed to the user than the case of using the displaying method in the related art.

Hereinbefore, the exemplary embodiments of the invention are described with reference to the attached drawings, but the present invention is not limited to the aforementioned embodiments. It should be understood by those skilled in the art that various modifications, combinations, sub-combinations, and altercations may occur depending on design requirements and other factors insofar as they are within the scope of the appended claims or the equivalents thereof.

For example, in the aforementioned embodiments, as shown in FIG. 13, in the display apparatus 100 according to the embodiment of the invention, the controller 108 is configured to include the displaying-number determining unit 120, the displaying position setting unit 122, and the display controller 124. However, the configuration of the display apparatus according to the embodiment of the invention is not limited to the aforementioned configuration. For example, the display apparatus according to the embodiment of the invention may be implemented by configuring each of the displaying-number determining unit 120, the displaying position setting unit 122, and the display controller 124 shown in FIG. 13 with individual circuit. In this confirmation, since the display apparatus according to the embodiment of the invention may implement the process (1) (displaying-number determining process) to the process (3) (displaying process), the same effects of the display apparatus 100 shown in FIG. 13 may be obtained.

In addition, in the above embodiment, although the programs of allowing the computer to function as the display apparatus 100 according to the embodiment of the invention is provided, the embodiment of the invention may also provide the recording medium storing the programs.

Since the aforementioned configurations are exemplary embodiments of the invention, the configurations are within the scope of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a displaying position setting unit that sets displaying positions of the contents data based on a display starting position, at which the displaying of the contents data is started; and
a display controller that allows the contents data displayed on the display screen to be moved from the display starting position toward the displaying positions so as to be displayed based on the display starting position and the displaying positions set by the displaying position setting unit.

2. The display apparatus according to claim 1, further comprising a contents data input unit to which the contents data are input,
wherein the displaying position setting unit determines the display starting position based on a position provided by the contents data input unit to which the contents data are input.

3. The display apparatus according to claim 2,
wherein the display controller derives distances between the display starting position and the displaying positions based on the display starting position and the set displaying positions to display the contents data in the order from the displaying position according to the length of the derived distance.

4. The display apparatus according to claim 1, further comprising a displaying-number determining unit that determines a displaying number of contents data displayed on a display screen,
wherein the displaying position setting unit determines displaying sizes of the contents data displayed on the display screen based on the displaying number determined by the displaying-number determining unit, and
wherein the display controller allows the contents data to be displayed in sizes according to the displaying sizes determined by the displaying position setting unit.

5. The display apparatus according to claim 4, wherein the displaying position setting unit further determines displaying sizes of the contents data based on meta information set in the contents data.

6. The display apparatus according to any one of claims 1 to 5, wherein the displaying position setting unit sets the displaying position in a three-dimensional space defined by a horizontal direction and a vertical direction of the display screen and a perpendicular direction with respect to the display screen.

7. The display apparatus according to any one of claims 1 to 5, wherein the displaying position setting unit sets the displaying position in a two-dimensional plane defined by a horizontal direction and a vertical direction of the display screen.

8. A displaying method comprising the steps of:
setting displaying positions of the contents data based on a display starting position, at which the displaying of the contents data is started; and
allowing the contents data displayed on the display screen to be moved from the display starting position toward the displaying positions so as to be displayed based on the display starting position and the displaying positions set by the displaying position setting unit.

9. A program causing a computer to execute:
a function of setting displaying positions of the contents data based on a display starting position, at which the displaying of the contents data is started; and
a function of allowing the contents data displayed on the display screen to be moved from the display starting position toward the displaying positions so as to be displayed based on the display starting position and the displaying positions set by the displaying position setting unit.
